(19) United States
(12) Patent Application Publication
(10) Pub. No.: US 2013/0039381 A1
(43) Pub. Date: Feb. 14, 2013

(54) METHOD AND EQUIPMENT FOR CHARACTERIZING THE SURFACE OF SOLID MATERIALS

(71) Applicants: Bertrand Pavageau, Villenave D'Ornon (FR); Matthieu Guirardel, Bordeaux (FR); Julien Jolly, Talence (FR)

(72) Inventors: Bertrand Pavageau, Villenave D'Ornon (FR); Matthieu Guirardel, Bordeaux (FR); Julien Jolly, Talence (FR)

(73) Assignee: Rhodia Operations, Aubervilliers (FR)

(21) Appl. No.: 13/514,967

(22) PCT Filed: Dec. 8, 2010
(86) PCT No.: PCT/FR2010/052644

§ 371 Date: Oct. 26, 2012

(30) Foreign Application Priority Data
Dec. 8, 2009 (FR) 09 58756

(51) Int. Cl. G01K 17/00; G01J 5/02

(52) U.S. Cl. 374/29; 374/E17.001

(57) ABSTRACT

The aim of the invention is to improve the surface characterization of solid materials, facilitating the implementation thereof, while producing reliable and accurate results. The method of the invention comprises the following steps:
obtaining a material (M) to be characterized, in powder form, and a gas mixture (G) containing a probe molecule (S) that can interact with the material,
performing gas percolation through the material by flowing the gas mixture into the free spaces between the grains of the material, while leaving said grains in contact with each other,
during the gas percolation through the material (M), measuring a radiative heat flux (F) emitted by the material, and
at least one surface characteristic relating to the material (M) is deduced from the radiative heat flux (F) measurements.

The present invention relates to a method and equipment for characterizing the surface of solid materials.

The aim of the invention is particularly, but not restrictively, that of characterizing adsorption properties and catalytic activity properties of powder materials used in various gas treatment applications, for example for depollution purposes.

Characterizing such properties is currently difficult. In the case of the determination of the specific surface area of an adsorbent, for example, numerous methods are based on measurements of quantities of gas adsorbed and desorbed with a sample of the material to be characterized, by means of the frequently difficult use of ad hoc specific equipment.

Recently, US-A-2007/0092974 and U.S. Pat. No. 6,808,928 suggested characterizing the adsorption properties of a material by measuring the changes in temperature when the material is placed in contact with a gaseous adsorbent: indeed, these changes in temperature are associated with the physical adsorption and desorption phenomena between the adsorbent and the adsorbate.

Although this idea is appealing, the process suggested by said document is both difficult to implement and inaccurate: indeed, this document envisages placing the material in a tight chamber, before allowing the gaseous adsorbate flowing on contact with the material into the chamber, fluidizing said adsorbate at least partially if applicable, whereas the heat fluxes from the material during the adsorption and desorption phenomena are observed through a transparent window.

The aim of the present invention is that of providing a method and equipment that are easier to implement, while producing reliable and accurate results.

For this purpose, the invention relates to a method for characterizing the surface of solid materials, as defined in claim 1.

The invention also relates to equipment for characterizing the surface of solid materials, as defined in claim 16.

The underlying idea of the invention is that of trying to create intimate, and thus effective, contact between probe molecules and the grains of a powder material to be characterized, and, under these conditions, favoring the detection of thermal phenomena on the surface of these grains, associated with physical, chemical or physico-chemical interaction between the material and the probe molecule. For this purpose, the material and probe molecule are caused to interact by means of percolation, i.e. by having a gas flow containing the probe molecules pass through the powder material: the gas mixture containing these probe molecules thus flows into the free spaces between the grains of the material in contact with each other. Moreover, unlike a fluidization gas flow, the percolation gas flow offers the noteworthy advantage of somewhat thermally insulating the material interacting with the probe molecules, due to the low heat conductivity of the gas mixture in which the grains of the material are “immersed”. This thermal insulation, by the percolation gas mixture, of the interactions between the material and the probe molecules renders the thermal surface phenomena arising from said interaction readily and effectively detectable. The processing of these “thermal responses”, particularly by infrared thermography, makes it possible to deduce, typically with suitable calculations, surface characteristics relating to the material, with remarkable accuracy and reliability. Examples of this are given hereinafter.

It should be noted that, according to the invention, the term “powder material” does not refer to a pre-existing strict classification relating to powders. On the contrary, the invention applies generally to materials having a finely divided or porous solid structure, for treating the grains thereof in contact with each other by gas percolation.

In practice, the invention is particularly each to implement. In particular, it does not require tight confinement of the material to be characterized and thermal response measurements are made by means of direct observations of the material during gas percolation. It is thus understood that the corresponding procedure times are short and can be carried out in quick succession: as such, the term “high-speed” surface characterization can be used. The implementation of the invention thus proves to be economical, particularly as small quantities of the materials to be characterized and the gas mixtures used are sufficient to provide reliable and significant data, in view of the accuracy of the thermal responses obtained and the performance of the measurements relating to these thermal responses. Typically, the mass of the material characterized in this way is less than 100 mg.

As explained in more detail hereinafter, the invention applies to various material/probe material pairings: absorbent/adsorbate, oxidant/reduction agent, acid/base and base/acid pairings are thus envisaged. In this way, according to the circumstances, the surface characteristic deduced relates, among other things, to the physical adsorption properties or the oxidation-reduction catalytic activity of the material to be characterized. Moreover, according to the envisaged applications, the effect of additional operating parameters may be taken into account by the invention. This particularly applies to the material temperature, by means of suitable heat regulation, as mentioned in more detail hereinafter.

Advantageous additional features of the method and equipment according to the invention, taken alone or according to any technical possible combinations, are specified in dependent claims 2 to 15 and 17 to 20.

The invention will be understood more clearly on reading the following description, given as a non-limiting illustration, with reference to the figures wherein:

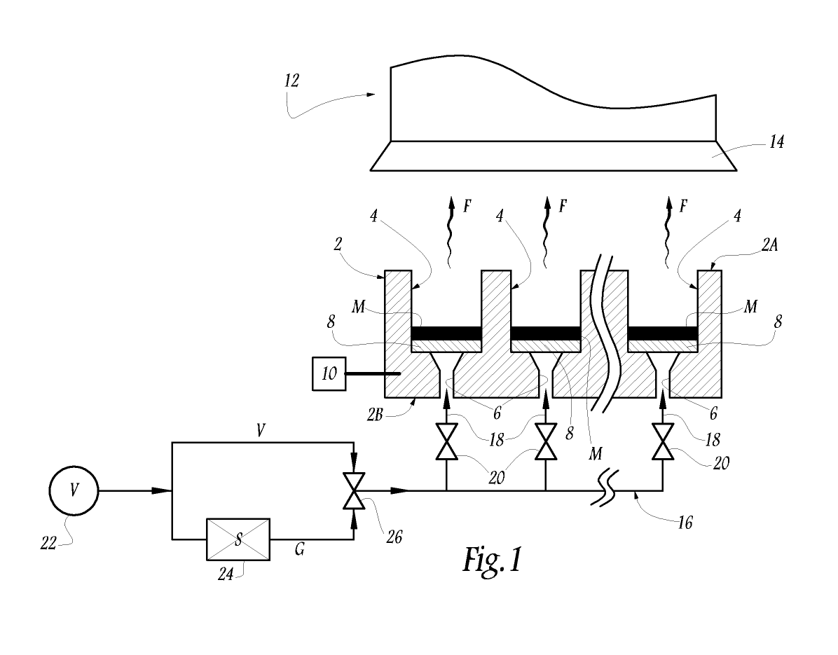

FIG. 1 is a diagram of equipment according to the invention;

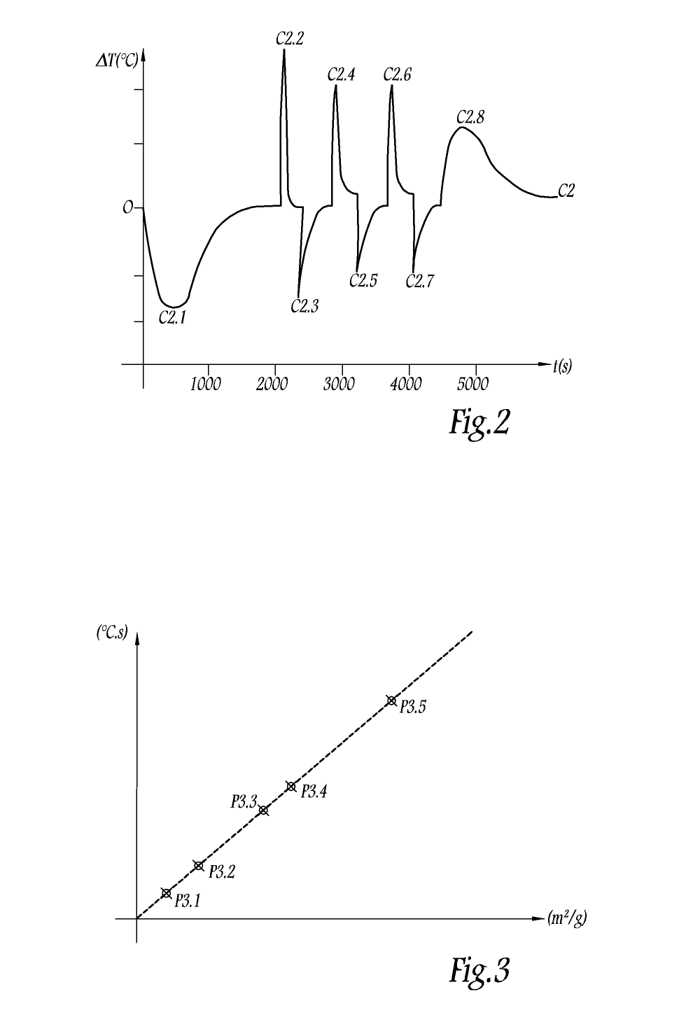

FIG. 2 is a graph illustrating the variation, over time, of temperature measurements for a material, carried out within the scope of a first example of the invention;

FIG. 3 is a graph illustrating the correlation between some of the measurements in FIG. 2 and a predefined value of the specific surface area of the material, for a plurality of forms of said material, having different respective values for the specific surface area thereof;

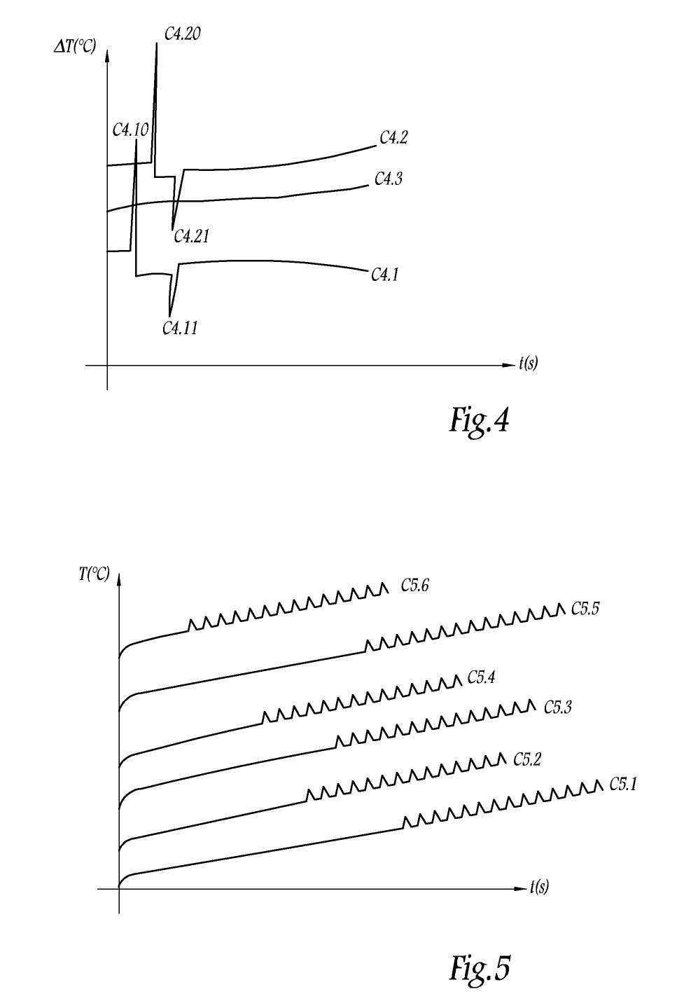

FIGS. 4 and 5 are graphs similar to that in FIG. 2, relating to the second and third examples of the invention, respectively; and

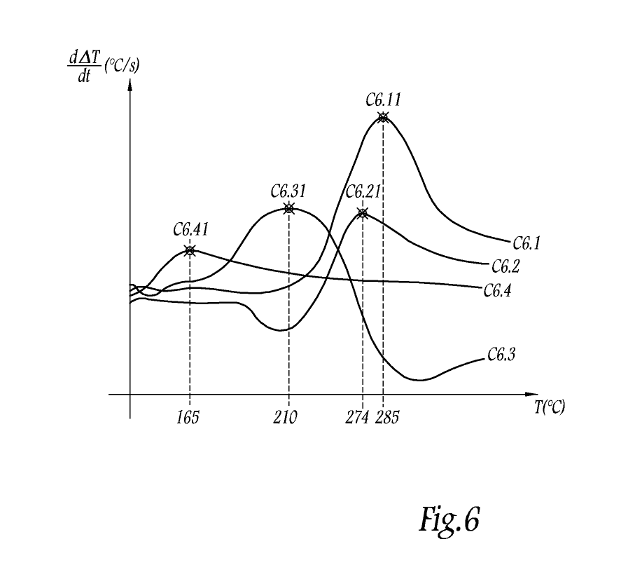

FIG. 6 is a graph illustrating the variation, as a function of temperature, of a temperature time differential for four materials characterized within the scope of a fourth example of the invention.

The equipment according to the invention, illustrated schematically in FIG. 1, comprises a block 2 wherein a plurality of separate wells 4 are defined. The wells 4, at one of the ends thereof, open freely to the outside, leading to one face 2A of the block 2. At the opposite end thereof, each well 4 is sealed with a base 4A connected to the opposite face 2B of the block 2 by a conduit 6 defined in the block.

Each well 4 is suitable for receiving a material to be characterized M therein. In practice, this material M is provided in powder form deposited on the base 4A of the well 4, with the insertion of a sintered support member 8 extending through the opening of the conduit 6 in the well 4.

The sintered members 8 have a porosity selected such that the member supports the powder material M mechanically, without said material penetrating the pores of the sintered member and such that the sintered member is not gas-tight, i.e. that said sintered member is suitable for being passed from one end to the other by a gas flow. Typically, the pores of the sintered members 8 are in the region of one micron in size.

Advantageously, the block 2 is thermostatically controlled, i.e. the operating temperature thereof can be set to an adjustable value, by means of a thermostat referenced 10 in FIG. 1. This heat regulation may be applied equally well to the entire block 2, in that all the wells 4 have a common operating temperature, or individually to each well. In practice, the corresponding heat regulation means, not shown in FIG. 1, may adopt various forms: in this way, electrical heating cartridges or a heat transfer fluid flow circuit may be incorporated in the thickness of the block 2.

It is understood that the material forming the block 2 is selected, among other things, according to the heat regulation requirements for the various wells 4. In the example illustrated, this block 2 is in the form of one piece, made of stainless steel: in this case, the regulated temperature range may be between 25 and 550° C. If this temperature reaches 1200° C., ceramics can be used, with the block 2 being comparable to a kiln in this case.

The equipment according to the invention also comprises an infrared camera 12 wherein the lens 14 is arranged facing the face 2A of the block 2. This camera may be positioned such that the optical axis thereof is perpendicular to the face 2A of the block: in this case, the thermographic measurement is made using a mirror positioned at 45° above the face 2A, suitable for reflecting the heat radiation toward the camera. This design makes it possible to protect the camera in the event of emissions of corrosive gas or any other corrosive flows liable to damage the integrity of the heat camera.

The camera 12 is suitable for detecting radiation in the infrared range, typically equivalent to the spectral ranges between 7.5 and 13 μm, and producing images of said radiation. In operation, these images are sent to computer processing means, not shown, capable of determining a representative value of the temperature of the object emitting the radiation detected by the camera 12. More specifically, in order to obtain an absolute temperature value using the camera 12, it is necessary for the emissivity observed to be known or measured beforehand by means of suitable radiative calibration. In practice, it is not necessary to know the absolute temperature if the data measured is processed by means of mutual comparison, as explained in detail hereinafter. Similarly, the grayscale camera signal can also be used.

For example, the camera 12 is a camera marketed by FLIR Systems, under the reference “ThermoVision A20M”, wherein the output signals are processed by “ThermaCAM Researcher” (registered trademark) software.

As shown in FIG. 1, the equipment according to the invention further comprises a circuit 16 for supplying the conduits 6 with gas. More specifically, this circuit 16 includes gas inlets 18 respectively supplying the conduits 6, so as to open respectively into the bases 4A of the various wells 4. Each inlet 18 is provided with an electrovalve 20 or similar means, suitable for controlling the gas flow rate circulating in the corresponding inlet 18. Upstream from the electrovalve 20 thereof, the inlets 18 are supplied with a gas mixture G containing, with a defined concentration, a probe molecule S.

In practice, the gas mixture G is supplied in various ways. A first solution consists of using a source of this mixture, suitable for direct connection at the input of the circuit 16. A further solution, shown in FIG. 1, consists of producing the gas mixture G from a source 22 of a carrier gas V, supplying a unit 24 for producing probe molecules S. Advantageously, the circuit 16 makes it possible, alternating with the gas mixture G, to supply the inlets 18 with a gas devoid of probe molecules S. In the example shown, the source 22 of carrier gas V can be used for this purpose, using a multi-way valve 26, positioned upstream from the electrovalves 20 and supplied with the gas mixture from the unit 24 and directly by the source 22.

Before describing specific examples of use of the equipment in FIG. 1, the generic operation thereof is described hereinafter.

Via suitable control of one of the electrovalves 20, the corresponding inlet 18 supplies the base 4A of the associated well 4 with gas mixture G. After passing through the sintered member 8, this gas mixture reaches the powder material M and progresses in the thickness thereof, flowing into the free spaces between the grains of said material, until it has passed through the entire material. In other words, within the well 4, gas percolation of the powder material M is carried out. The probe molecules S contained in the gas mixture then interact with the grains of material M: this interaction may, according to the circumstances, be physical, chemical or physico-chemical in nature. In any case, the thermal phenomena associated with this interaction are of interest. In other words, depending on whether this interaction is exothermic or endothermic, the grains of powder material M jointly emit, from the surface thereof, a radiative heat flux, as shown by the arrow F in FIG. 1.

This heat flux F is detected by the camera 12 and thus processed by computer processing means connected to the camera, to determine a representative value of the surface temperature of the material M arising from the interaction thereof with the probe molecule S: in this context, the heat flow F displays a remarkable quality, associated with the intimate percolation contact between the grains of material and the gas mixture G containing the probe molecules and with the heat insulation of the interaction between the material and the probe molecules, by the percolation gas phase wherein the material M is “immersed”.

In practice, the quantity of material M present in the well 4 is small: it is typically less than 100 mg. Furthermore, it is understood that the flow rate of the gas mixture G in the inlet 18 is selected at a sufficiently low level to obtain the desired percolation effect, particularly preventing the gas mixture from being able to lift or move the grains of material M resting in the base 4A of the well and remaining in continuous contact with each other: the gas flow rate from the inlet 18 is typically less than 100 ml/min, or between 10 and 70 ml/min. Advantageously, the sintered member 8 helps homogenize the flow of the flux of gas mixture G just before it reaches and passes through the material M. Indeed, due to the small dimensions of the well 4, particularly of the conduit 6 which is in the region of one millimeter in diameter, the flow of gas mixture G is laminar and focused at the opening of the conduit 6 into the well 4: the sintered member 8 makes it possible to create turbulences in the gas mixture flux and also enables spreading thereof on the site of the material M facing said sintered member. In other words, the sintered element 8 “breaks” the flux of gas mixture G entering the well 4, by homogenizing the flux throughout the diameter of the well at the material M.

The method described above for one of the wells 4 can be carried out for all the wells 4, either concomitantly for at least some thereof, as for examples 1, 2 and 4 detailed hereinafter, or sequentially for at least some thereof, as for example 3 hereinafter. Obviously, the camera 12 has a sufficient spatial resolution to differentiate the respective heat fluxes F from the various wells 4, so as to process the data corresponding to each of these fluxes F separately.

Advantageously, during the use of the equipment in FIG. 1, the wells 4 are associated in pairs such that, one of the wells 4 with an intake of the gas mixture G is associated with another well 4 wherein the gas mixture inlet is sealed, by means of a corresponding control of the electrovalves 20 associated with the two wells of the pair defined. In this way, provided that both wells 4 of this pair contain the same quantity of the same powder material M, the difference between the thermal measurement for the material M contained in one of these two wells and the thermal measurement for the material M of the other well can be calculated to obtain an item of thermal data not influenced by the emissivity of the equipment and/or thermal fluctuations in the external environment. In other words, the well 4 of the above-mentioned pair, wherein the mixture G does not pass through the material M, serves as a comparative reference for the thermal measurement relating to the other well of said pair. Such pairs of wells 4 are used in examples 1, 2 and 4 hereinafter.

If applicable, the heat regulation of the block 2 is active during the use of the equipment: while the gas mixture G percolates through the material M, the overall temperature of the material is set to a value adjusted using the thermostat 10, it being understood that the thermal surface phenomena, arising from the interaction between the material M and the probe molecule S, overlaps with the overall temperature of the material regulated in this way. In practice, this heat regulation can, over time, be static, as in example 1 hereinafter, or dynamic, either by means of a gradient, as in examples 2 and 4 hereinafter, or in successive stages, as in example 3 hereinafter.

Obviously, the equipment according to the invention is advantageously controlled with a control interface, such as a “Labview” interface. This control interface controls the circuit 16, particularly the electrovalves 20 and, if applicable, the unit 24 for producing probe molecules S and the thermostat 10.

The method and equipment according to the invention may be applied to various material M/probe molecule S pairings depending on the surface characterization sought, particularly depending on whether this characterization relates to the physical adsorption properties of the material, the oxidation-reduction catalytic activity of the material, or the acid or base functions of the material.

A preferential list of inorganic materials M is as follows: alumina, silica, zeolite, aluminosilicate minerals, rare earth oxides (cerium, lanthanum, praesodymium, zirconium, etc., alone or in a mixture) and any of the above-mentioned materials charged with at least one noble metal selected from gold, platinum, palladium, etc.

The material M may also be organic, provided that the morphological features thereof are suitable for the invention (finely divided and/or high-porosity solid): in this case, it particularly consists of polymers (polyamines, polyphosphazenes, phosphorous derivatives) or low molar mass organic molecules.

Similarly, it is possible to characterize hybrid materials, i.e. with both inorganic and organic chemical functions.

For the characterization of physical adsorption properties of the material M, particularly selected from the above list, the measurements with the camera 12 make it possible to deduce, among other things, the ability of the material M to adsorb the probe molecule S, as in example 2 hereinafter, and a specific surface area value for the material M, as in example 1 hereinafter.

For the characterization of the catalytic activity by means of oxidation-reduction of the material M, particularly when said material is selected from the list defined above, the measurements with the camera 12 make it possible to deduce, among other things, the ignition temperature of the probe molecule S in the presence of the material, as in example 3 hereinafter, and a thermal profile of the reducibility of the material M, as in example 4 hereinafter.

Depending on the surface characterization sought, the probe molecule S is preferentially selected from hydrocarbons, fly ash, volatile organic compounds, particularly isopropanol, carbon monoxide, carbon dioxide, carboxylic acids, alkanes, alkynes, alkenes, alcohols, aromatic compounds, thiols, esters, ketones, aldehydes, amides, amines, N-propylamine, particularly isopropylamine, ammonia, lutidine, pyridine, hydrogen, fluorine, neon, nitrile, quinoline, and a mixture of at least some thereof.

In all surface characterization scenarios, the invention advantageously makes it possible to use the same family of probe molecules S, for example various alcohols, while adjusting the length of the hydrocarbon chain of the alcohols: it is thus possible to characterize the impact of the steric size of the probe molecules, depending on whether said probe molecules reach some surface sites of the material M or not, and thus determine a microporosity of said material.

Moreover, in all surface characterization scenarios, a preferential list of carrier gases V is as follows: air, nitrogen, oxygen, argon, helium and a mixture of at least some thereof.

Four examples of embodiments of the invention, particularly using the equipment in FIG. 1 will now be described.

### EXAMPLE 1

This example relates to the surface characterization of cerium oxide (CeO₂), in respect of the physical adsorption properties thereof.

It involves the use of five cerium oxides with an identical particle size, for example 300 μm, but different microporosities, such that they have different respective values for the specific surface area thereof, these values being known in advance for invention performance verification purposes.

For each of these cerium oxides, eighty milligrams of powder is used, distributed in halves into two wells 4 of the block 2.

The probe molecules S used are isopropanol molecules. For example, the gas mixture G is obtained, in the unit 24, by bubbling nitrogen from the source 22, in a liquid isopropanol solution. The quantity of isopropanol vaporized in the unit 24 is regulated by the temperature of said unit. For example, the molar concentration of isopropanol in the gas mixture G used is 8.73%. The gas flow rate through the inlets 18 is equal to 60 ml/min.

The block 2 is heat-regulated at a fixed temperature value which, in practice, may be the ambient temperature, which means that the thermostat 10 is inactivated.

For each of the five pairs of wells 4 containing cerium oxides having different specific surface areas, one of the two wells is supplied with nitrogen containing isopropanol molecules, while the electrovalve 20 of the other well is closed.

Using the camera 12, the radiative heat fluxes F emitted by the wells 4 of each pair are measured. FIG. 2 shows a curve C2 corresponding to the variation of the difference (ST) in the respective thermal measurements for both wells of one of the five pairs mentioned above, as a function of the time (t), this variation being linked with cerium oxide adsorption and desorption cycles:
for the first 2000 seconds, the well 4 is supplied with pure nitrogen in order to “clean” the cerium oxide, particularly by desorbing previously present water molecules, explaining the cooling referenced C2.1 in FIG. 2;
then, for approximately 200 seconds, the mixture G of nitrogen and isopropanol molecules are circulated through the cerium oxide; isopropanol molecules are then adsorbed on the surface of the grains of this material and an exothermic phenomenon is observed, as shown by the peak referenced C2.2 in FIG. 2;
then, for approximately 800 seconds, the circulation of the mixture containing isopropanol is discontinued, in favor of a supply of exclusively nitrogen gas to the wells 4; desorption of the previously absorbed isopropanol molecules, represented by a cooling peak C2.3, is observed;
the adsorption and desorption cycle described above is then repeated twice, thus successively observing an exothermic peak C2.4 and an endothermic peak C2.5, followed by a further exothermic peak C2.6 and an exothermic peak C2.7; and
finally, in a final phase, the gas intake is discontinued completely in the wells 4; however, heating C2.8 is observed, which is explained by the adsorption of the water molecules found in the ambient environment.

FIG. 2 thus demonstrates that the method and equipment according to the invention detect, with a high degree of accuracy, the surface temperature variations of the material M associated with isopropanol adsorption/desorption.

To demonstrate the performance of the invention, FIG. 3 contains five points P3.1 to P3.5: the respective x-values of these five points consist of the respective specific surface area values for the five cerium oxides used, whereas the respective y-values of these five points consist of the exothermic peak C2.6 area measured specifically for each cerium oxide used.

In view of the quasiperfect alignment of points P3.1 to P3.5, this infers a clear correlation between the predetermined quantification of the specific surface area of the materials used and the data acquired with the method and equipment according to the invention.

### EXAMPLE 2

Example 2 relates to the surface characterization of rare earth oxides, in respect of the physical adsorption properties thereof.

The materials used are two different forms of cerium oxide (CeO₂) and a composite silicon and zirconium oxide (ZrO₂SiO₂). The probe molecule S is carbon dioxide, supplied by an ad hoc source.

The same quantity of rare earth oxide, in the region of some tens of milligrams, is placed in the wells 4: two wells, associated in a pair, receive the first form of cerium oxide, two other wells receive the second form of cerium oxide, and two other wells receive the composite silicon and zirconium oxide.

For each pair of wells 4 defined, carbon dioxide is sent through the bottom 4A of one of the wells, whereas the other well is not flushed with the gas.

FIG. 4 shows three curves respectively associated with the three materials used, i.e. the curves C4.1 and C4.2 associated with the two forms of cerium oxide, respectively, and a curve C4.3 associated with the silicon and zirconium oxide. Each curve C4.1, C4.2, C4.3 consists of the variation, over time, of the difference (ΔT) between the temperature measured for the well of the pair associated with the corresponding material, supplied with carbon dioxide, and the temperature measured for the other well in the pair. It is noted that the curves C4.1 and C4.2 each have an exothermic peak C4.10, C4.20. These exothermic peaks C4.10 and C4.20 occur at successive times and are each followed by an endothermic peak C4.11, C4.21.

This observation is explained by the temperature conditions in which the measurements are made: indeed, the temperature of the block 2 is regulated, so as to follow a rising gradient, which is linear over time, such that said temperature progressively changes from 150° C. to 250° C. In this way, in view of the presence of the exothermic peaks C4.10 and C4.20, it can be inferred that both forms of cerium oxide adsorb carbon dioxide at different respective overall temperatures, and, at a slightly higher temperature, they desorb the carbon dioxide molecules previously adsorbed.

On the other hand, the composite silicon and zirconium oxide does not have the ability to adsorb carbon dioxide, regardless of the overall temperature thereof in the tested range.

### EXAMPLE 3

This example relates to the surface characterization of various rare earth oxides, in respect of the isopropanol oxidation potential thereof.

FIG. 5 shows six curves C5.1 to C5.6. Each curve consists of the variation of the temperature (T) of each rare earth oxide, measured with the camera 12, as a function of the time (t). Curves C5.1 to C5.6 are thus respectively associated with a first form of cerium oxide (CeO₂), three different forms of composite cerium, zirconium and lanthanum oxide (CeZrLa), and two other forms of cerium oxide (CeO₂).

In this example, the carrier gas of the gas mixture is air and the isopropanol concentration is 8.7%.

The curves C5.1 to C5.6 are obtained while the overall temperature of the oxides used changes: this overall temperature changes from 120 to 300° C., in incremental stages of 5°. At each temperature stage, once the value thereof has stabilized, the gas mixture containing isopropanol molecules is allowed to enter, sequentially, each of the wells 4 respectively containing the six oxides used: this gas mixture thus flows for a few seconds into a first well 4, and stops in favor of another wells 4, and so on.

In this way, it is possible to deduce a value of the isopropanol ignition temperature with the oxides tested, i.e. the temperature at which the catalytic oxidation with these materials starts. Indeed, this catalytic oxidation is an exothermic reaction which, in FIG. 5, is conveyed by exothermic peaks: for each of the curves C5.1 to C5.6, it is possible to determine the temperature at which said exothermic peaks occur.

### EXAMPLE 4

This example relates to the surface characterization of rare earth oxides, charged with gold in one case, in respective of the reducibility thereof.

The gas mixture used in this case consists of nitrogen containing isopropanol probe molecules.

Each material characterized is placed, with a quantity of 20 mg, in two wells 4: one of these wells is supplied, continually over time, with said gas mixture, whereas the gas mixture does not flow through the other well so that it serves as a comparative reference for the first well.

Moreover, the temperature of the block 2 is regulated so as to follow a rising gradient, which is linear over time, for example 3° C./minute, the overall temperature of the characterized materials thus changing from 120° C. to 500° C.

For each characterized material, the camera 12 is used to measure the respective thermal responses of the well 4 supplied with gas mixture and the reference well not supplied with gas. It is thus possible to represent the time differential (dAT) of the difference of the two thermal measurements mentioned above, as a function of the temperature of the reference well, which is directly linked with the set-point temperature of the thermostat 10 of the block 2. The four curves, respectively associated with the four materials to be characterized, are shown in FIG. 6.

Each curve C6.1, C6.2, C6.3, C6.4 represents the oxygen atoms that the characterized material is capable of releasing, as a function of the overall temperature thereof. In other words, these curves consist of thermal profiles of the reducibility of the materials used.

In this way, each of the curves mentioned above has a vertex, referenced C6.11, C6.21, C6.31, C6.41 respectively, wherein the temperature consists of the temperature at which the corresponding material is capable of releasing the most oxygen atoms to oxidize the isopropanol probe molecules:
two forms of composite, cerium, zirconium and lanthanum oxide (CeZrLa), respectively associated with the curves C6.1 and C6.2, release a maximum amount of oxygen atoms to oxidize isopropanol at approximately 285 and 274° C.,
cerium oxide (CeO₂), which is associated with the curve C6.3, releases a maximum amount of oxygen atoms at approximately 210° C., and
when this cerium oxide is charged with gold (Au/CeO₂), a maximum amount of oxygen atoms is accessible from 165° C., as seen in the curve C6.4.

1-18. (canceled)

19. A method for characterizing the surface of a solid powder material, comprising:
percolating a gas mixture comprising a probe molecule through said material,
wherein said probe molecule is capable of interacting with the material, and
further wherein percolating the gas mixture comprises causing the gas mixture to flow through free spaces between grains of the material while said grains remain in contact with each other;
measuring a radiative heat flux emitted by the material during the gas percolation through the material; and
determining at least one surface characteristic of the material based on the measurement of the radiative heat flux.

20. The method of claim 19, further comprising measuring the radiative heat flux by infrared thermography.

21. The method of claim 19, further comprising regulating a temperature of the material during the flow of the gas mixture through the material.

22. The method of claim 21, wherein regulating the temperature comprises maintaining the temperature at a preset value.

23. The method of claim 21, wherein regulating the temperature comprises varying the temperature of the material.

24. The method of claim 23, wherein varying the temperature of the material comprises a linear variation of the temperature.

25. The method of claim 19, wherein determining the at least one surface characteristic of the material comprises comparing the measurement of the radiative heat flux to a reference measurement,
wherein the reference measurement is obtainable by measuring a reference radiative heat flux emitted by the same type of material, wherein said same type of material is not contacted with the gas mixture.

26. The method of claim 19, wherein the material to be characterized comprises an alumina, a silica, a zeolite, an aluminosilicate mineral, a rare earth oxide, a polymer, an organic molecule, or a mixture thereof.

27. The method of claim 26, wherein the rare earth oxide comprises a cerium, a lanthanum, a praesodymium, and/or a zirconium oxide.

28. The method of claim 26, wherein the alumina, the silica, the zeolite, the aluminosilicate mineral, or the rare earth oxide are charged with at least one noble metal.

29. The method of claim 26, wherein said polymer comprises a polyamines, a polyphosphozene, or a phosphorous derivative thereof.

30. The method of claim 19, wherein the material comprises an adsorbent and the probe comprises an adsorbate.

31. The method of claim 30, wherein the at least one surface characteristic comprises an ability of the material to physically adsorb the probe molecule.

32. The method of claim 30, wherein the at least one surface characteristic comprises a surface area of the material.

33. The method of claim 19, wherein the material comprises an oxidant and the probe comprises a reducing agent.

34. The method of claim 33, wherein the at least one surface characteristic comprises a thermal profile of the reducibility of the material.

35. The method of claim 19, wherein:
the material comprises an acid and the probe comprises a base, or
the material comprises a base and the probe comprises an acid.

36. The method of claim 19, wherein the probe comprises a hydrocarbon, a fly ash, a volatile organic compound, carbon monoxide, carbon dioxide, a carboxylic acid, an alkane, an alkyne, an alkene, an alcohol, an aromatic compound, a thiol, an ester, a ketone, an aldehyde, an amide, an amine, ammonia, a lutidine, a pyridine, hydrogen, fluorine, neon, a nitrile, quinoline, or a mixture thereof.

37. The method of claim 19, wherein the gas mixture further comprises a carrier gas comprising air, nitrogen, oxygen, argon, helium or a mixture thereof.

38. An device adapted to characterize the surface of a solid powder material, comprising:
at least one gas percolation well adapted to receive the material,
a gas inlet opening into a base of the at least one gas percolation well,
a gas mixture comprising a probe molecule capable of interacting with the material, and
a measurement device for measuring a radiative heat flux emitted by the material,
wherein said measurement device is adapted to observe the opening of the at least one gas percolation well from outside of the at least one well.

39. The device of claim 38, wherein the measurement device comprises an infrared camera.

40. The device of claim 38, wherein the device comprises a plurality of separate gas percolation wells arranged adjacently and adapted to be observed by the measurement device.

41. The device of claim 38, wherein the at least one gas percolation well is formed in a thermostatically-controlled block.

42. The device of claim 38, wherein the device comprises a sintered member over the gas inlet and resting on the base of the at least one gas percolation well,
wherein the sintered member is adapted to support the material.
